(19) United States
(12) Patent Application Publication
(10) Pub. No.: US 2009/0191376 A1
(43) Pub. Date: Jul. 30, 2009

(54) METHOD, APPARATUS, AND SYSTEM USING ADAPTER ASSEMBLY FOR MODIFYING SURFACES

(75) Inventors: Allen J. Rivard, White Bear Lake, MN (US); Galen A. Fitzel, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/022,408

(22) Filed: Jan. 30, 2008

(51) Int. Cl. B32B 3/06

(52) U.S. Cl. 428/100; 428/99

(57) ABSTRACT

Method, system, and apparatus for use in enabling users to quickly change surface modifying articles and for supporting the surface modifying articles during a surface modification operation.

### BACKGROUND

The present disclosure is directed to method, system, and apparatus for modifying or conditioning a working surface. More particularly, it is directed to method, apparatus, and system for enabling the quick and easy changing of surface modifying articles relative to a power tool assembly, and for uniformly supporting flexible surface modifying articles during surface modification.

A variety of attachment systems have been employed to attach an abrasive article, such as an abrasive sheet or disc, to a power abrading tool, such as a sanding tool, whereby the former is driven by the latter. Abrasive sheets and discs have relatively flexible constructions and are available in a wide variety of sizes and shapes. Typically, the abrasive particles are on one major surface of a sheet or disc article. These kinds of abrasive sheets are normally held in place on the abrading tool by mechanical fasteners, such as a center bolt and washer and the like that require relatively considerable user manipulations to attach and detach for each abrasive disc replaced. With one kind of power tool the abrasive article is bolted to and supported by metal or hard felt on a driving element of the tool.

However, it is desirable to use abrasive articles that can be releaseably attached directly to power tools without manipulating the noted kinds of mechanical fasteners. Known abrasive articles for securing these to a power tool include the use of releasable types of attachment mechanisms, such as hook and loop fasteners. Releasable attachment mechanisms allow the abrasive article to be manually applied and peeled from the power tool. However, to use abrasive articles having releaseable attachment mechanisms, in combination, with such power tools, known approaches have included back-up and conversion pads. The back-up pads and conversion pads are mounted directly to the power tools and, in turn, such abrasive articles are removably attached to the pads. Thereafter, a user will mount and dismount or peel the abrasive articles from the pads without having to manipulate the mechanical fasteners noted above. In general, known conversion pads and back-up pad approaches perform satisfactorily. Nevertheless, there are on-going efforts to improve upon these approaches by providing methods, apparatus, and systems that enable effective and efficient peeling or removal of the abrasive articles from the pads. In some instances because a relatively strong gripping action is needed between the pad and the abrasive article during abrading, the subsequent peeling action may become harder than desired. It has been noted that during such peeling, the mating hook and loop fasteners become more tightly enmeshed, thereby hindering the removal operation.

Furthermore, it has been noted that heretofore known combinations of abrasive articles and pads do not provide methods, apparatus, or systems for providing the noted versatility and yet overcome formation of surface irregularities or blemishes, such as when abraded surfaces have areas of different hardness. For example, when sanding wood surfaces, the abrasive articles mounted on back-up pads or flexible conversion pads, such as of the non-woven kind may result in a dishing effect being created between the softwood (spring wood) grains and the hardwood (summer wood) grains. Dishing is generally considered a sculpting out of the softwood grain, relative to the hardwood grain, by a sander during sanding. It is essentially caused by the disparity of hardness between the softwood relative to the hardwood, thereby resulting in the sander causing an uneven or pitted surface when the abrading disc abrades into the softwood and grabs the same. Dishing is generally considered an unacceptable blemish in the surface appearance of wood following sanding.

### SUMMARY

Accordingly, needs exist for improved methods, systems, and apparatus for use in enabling users to quickly change surface modifying articles on a driving assembly of a power tool without using mechanical fastening elements particularly when removing surface modifying articles, and for supporting surface modifying articles while the latter is modifying surfaces, particularly those surfaces, having different hardness sections, by maintaining the surface modifying article in a modifying plane.

The present description provides an apparatus adapted to carry a flexible surface modifying article while modifying a working surface. The apparatus comprises: an adapter body having at least a first major surface; and a releasable attachment mechanism on the first major surface for releasable meshing engagement to a matable attaching mechanism of a flexible surface modifying article; the adapter body has a construction such that when the mating attaching mechanism of the flexible surface modifying article is peeled from meshing engagement from the mating attachment mechanism, tighter meshing engagement therebetween is inhibited because the adapter body resists bending.

The present description provides a method of enabling at least one flexible surface modifying article having a releasable attaching mechanism on one major surface thereof to be attached to and detached from an abrading tool having a driving member. The method comprises: providing an adapter body joinable to the driving member and having at least a first major surface with a releasable attaching mechanism, and a construction such that when the mating attaching mechanism of the flexible surface modifying article is peeled from meshing engagement from the mating releasable attachment mechanism, tighter meshing engagement therebetween is inhibited because the adapter body resists bending.

The present description provides a system for use in modifying a surface. The system comprises: a power tool; a driving assembly coupled to the power tool, the driving assembly includes a first major surface; a flexible surface modifying article; and an adapter body an adapter body having at least a first major surface; and a releasable attachment mechanism on the first major surface for releasable meshing engagement to a matable attaching mechanism of a flexible surface modifying article; the adapter body has a construction such that when the mating attaching mechanism of the flexible surface modifying article is peeled from meshing engagement from the mating attachment mechanism, tighter meshing engagement therebetween is inhibited because the adapter body resists bending.

The present description provides for an apparatus adapted to carry a flexible surface modifying article. The apparatus comprises: an adapter body including first and second opposing major surfaces, wherein the first major surface is adapted to be releaseably attached to a surface of a flexible surface modifying article, and the second major surface is adapted to be coupled to a driving element of a power driven assembly; the adapter body includes at least one stiffening portion that resists deformation of the flexible surface modifying article when the stiffening portion directly supports the flexible surface modifying article on the first major surface for modifying a working surface so that the flexible surface modifying article substantially remains in a surface modifying plane while modifying the working surface, the adapter body includes an attaching member located intermediate the first and second surfaces and has portions thereof that cooperate with a fastening element that attaches the adapter body to the driving element.

The present description provides a method of modifying a working surface. The method comprises: providing an adapter body having at least a first major surface; and a releasable attachment mechanism on the first major surface for releasable meshing engagement to a matable attaching mechanism of a flexible surface modifying article; the adapter body has a construction such that when the mating attaching mechanism of the flexible surface modifying article is peeled from meshing engagement from the mating attachment mechanism, tighter meshing engagement therebetween is inhibited because the adapter body resists bending, imparting movement to the surface modifying article to modify a working surface, and peeling the flexible surface modifying article.

An aspect of the present description includes method, system, and apparatus including an adapter assembly for enabling quick and easy removal or changing of surface modifying articles.

Still another aspect of the present description includes method, system, and apparatus including an adapter assembly for enabling the quick peeling of surface modifying articles therefrom without creating additional peeling resistances.

Another aspect of the present description includes method, system, and apparatus that achieve the foregoing in a highly versatile, economical, and reliable manner.

The aspects described herein are merely a few of the several that may be achieved by using the present description.

The foregoing descriptions thereof do not suggest that the present disclosure must only be utilized in a specific manner to attain the foregoing aspects.

These and other features and aspects of the present description will be more fully understood from the following detailed description of exemplary embodiments.

### BRIEF DESCRIPTION OF THE DRAWINGS

FIG. 1 is an exploded perspective schematic view of an adapter assembly of the present description for use in an attachment system that secures an abrasive article to a power tool driving assembly.

FIG. 2 is a cross-sectional schematic view of the adapter assembly of FIG. 1.

FIG. 3A is a planar schematic view of the adapter assembly of FIG. 2.

FIG. 3B is partial schematic view of another exemplary embodiment.

FIG. 4 is a schematic view of a surface modifying article being peeled from an adapter made according to the present invention.

### DETAILED DESCRIPTION

The words “a”, “an”, and “the” are used interchangeably to mean or more of the elements being described. By using words of orientation, such as “top”, “bottom”, and “backing” and the like for location of the various elements in the disclosed articles, we refer to the relative position of an element with respect to a horizontally-disposed body portion. It is not intended that the disclosed articles should have any particular orientation in space during or after their manufacture.

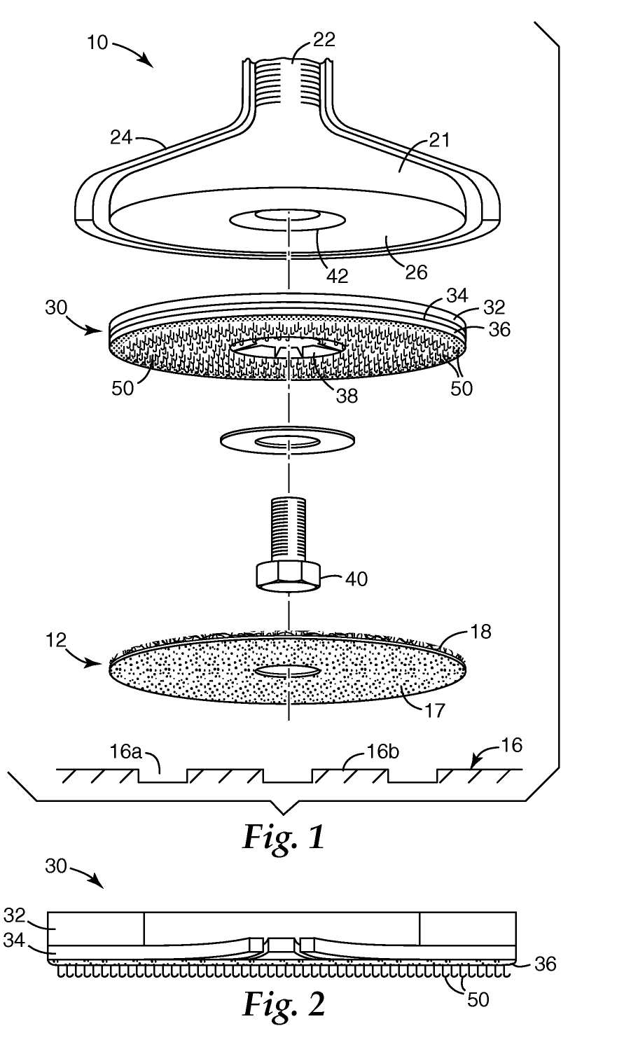

Reference is made to FIGS. 1-3A for illustrating one exemplary embodiment of the present disclosure, wherein there is envisioned use of an abrading power tool 10, such as a floor sanding machine 10, only a portion is illustrated, for rotating a surface modifying article 12, such as an abrasive article 12, for treating or modifying a working surface 16, such as wood flooring surface 16 or the like. The wood flooring surface 16 may include hardwood sections 16b and softwood sections 16a. While a rotary type sanding machine is described, it will be appreciated other abrading type devices may be used, such as orbital sanders, random orbital sanders, dual action sanders, vibratory sanders, corner sanders, buffers, and the like. Other hand held power tools are contemplated for use with the present description as well. The present description is not limited by the type of rotatable driving device or power tool to be used since even manual abrading may be enhanced by the present description. Also, while wood flooring is described as a surface being modified, it will be appreciated that other surfaces may be conditioned or modified by an appropriate surface modifying article and that surface modifying includes, but is not limited to grinding, blending, polishing, cleaning, or deburring surfaces.

In one exemplary embodiment, the flexible abrasive article 12 has abrasive particles 17 for performing the abrading. While the abrasive particles 17 are illustrated, the present description includes other kinds of surface treating articles, such as but not limited to those that bring about polishing, deburring and other known surface modifying operations. As noted, known abrasive articles 12 have releasable attachment mechanisms 18 that may include hook and loop systems, and such may be commercially available from the 3M Company under the designation “HOOKIT™” and “HOOKIT II™” systems. Other kinds of releasable attachment mechanisms may be used for effecting a releasable connection for the abrasive article 12, such as pressure sensitive adhesives. While the major surface carrying the abrasive particles is a planar disk, such a surface may have other configurations, such as annular or the like.

The floor sanding machine 10 of the present exemplary embodiment uses any suitable source of motive power for rotating a driving assembly 21 to which the abrasive articles are removably attached. For driving the driving assembly 21, the floor sanding machine 10 includes a rotary drive shaft assembly 22. The rotational speeds provided by the drive shaft assembly 22 may vary depending on the kinds of surface treatment to be accomplished by the abrasive article 12.

In the exemplary embodiment, the driving assembly 21 is housed within a housing assembly 24 having a generally planar and annular shaped back-up pad surface 26. While a back-up surface 26 is described, it will be appreciated that an independent back-up surface may be fixedly attached to the bottom of the driving assembly 21. While the back-up pad surface 26 in this embodiment is not formed with any fastening elements, it will be understood that the back-up pad surface 26 may be provided with fastening elements, such as releasable attaching mechanisms. Also, the back-up pad surface may be provided with a compressible felt covering (not shown).

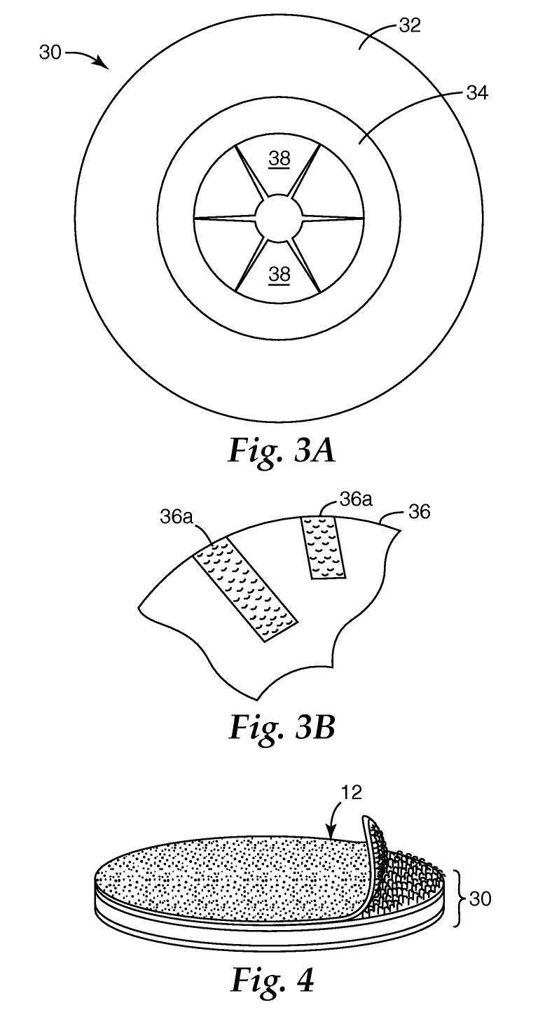

Reference is made to FIGS. 2 and 3A for illustrating one exemplary embodiment of an adapter assembly 30 for use as an interface in releaseably securing a power tool assembly 10 to a surface modifying article 12, whereby the former drives the latter.

In one exemplary embodiment, the adapter assembly 30 includes, in combination, a stiffening assembly 32, an attaching member 34, and a releasable attachment mechanism 36. The stiffening assembly 32 takes the form of a single circular plate like member 32 that has a size that conforms generally to the driving assembly 21. The stiffening assembly 32 may be arranged to provide support adjacent the periphery of the driving assembly 21. Other geometric configurations and sizes for the stiffening assembly 32 are contemplated as well. The present description calls for the degree of stiffening to be such that it facilitates peeling removal of the surface modifying article, such as shown in FIG. 4. It has been determined that a stiff or relatively rigid adapter assembly may facilitate this quick and relatively easy removal because it resists bending deformation during peeling. Heretofore known adapters, such as conversion pads, that are connected to a surface modifying article tend to bend from their horizontal plane during peeling. Such bending tends to give rise to an even more aggressive engagement between, for example, hook and loop type fastener systems during peeling removal. The stiffness provided by the present description, however, resists bending of the adapter during removal of the surface modifying and thus reduces or eliminates the more aggressive engagement that arises from bending. The degree of relative stiffness may vary depending on the disengagement forces considered necessary to peel.

Also, the stiffening provided may be sufficient enough to resist deformation of the surface modifying article while undergoing a surface modifying operation. The stiffening assembly 32 may be comprised of a material(s) that provides sufficient stiffness enough to resist deformation of the surface modifying article as the latter is undergoing a surface modifying operation, whereby the surface modifying article will remain in the same plane. Accordingly, for example, dishing of wood flooring is avoided because such stiffness enables a bridging of the hardwood and softwood areas by the surface modifying article.

While the stiffening assembly 32 may be on one side of the adapter, it will be appreciated that the stiffening assembly may be on the opposing major surface of the adapter. Alternatively, the stiffening assembly and the attaching member may be an integral body and the combination may in effect provide for the desired stiffening.

A wide variety of materials may be used for providing the stiffness that resists bending of the kind noted during peeling and/or resists deformation of the surface modifying article while undergoing a surface modifying operation. In general, stiffness for ensuring that the adapter assembly generally remains in plane during peeling is the stiffness that enables the surface modifying article to remain in an abrading or surface modifying plane during surface modification. It will be appreciated however that the degree of stiffness for one function is different than for the other function. For example, the material may be made of any suitable, plastic, metal, composite material that has desired thickness and/or modulus of elasticity properties needed to perform as intended. In one exemplary embodiment, the material may include but not be limited to any suitable polymeric material, or a high pressure laminate, such as Formica™ or other equivalent materials.

The stiffening assembly 32 has one major surface that may be adapted to contact the driving assembly 21 and an opposing major surface that may be adapted to be coupled to the attaching assembly 34 as by suitable adhesive system or other kind of suitable fastening system. Alternatively, the stiffening assembly 32 could, in combination, with the attaching member provide a stiffening portion with sufficient stiffness for the purposes intended by the present disclosure. Accordingly, the surface modifying abrasive article 12 remains in a surface modifying or abrading plane while performing such work or surface modifying operations. In this manner, the abrasive article 12 will be uniformly supported in a plane to perform a uniform sanding operation which avoids, for example, the dishing as the abrasive article bridges by extending over sections of differing hardness, such as hardwood and softwood areas of flooring. In addition, the stiffening assembly tends to keep edges of surfaces, such as, bowling alley lanes, being treated generally flat.

The attaching member 34 may be used for releaseably connecting the adapter assembly 30 to the driving assembly 21. In this embodiment, the attaching member 34 may be a generally planar annular member 34 that carries on its major surface the releasable attachment mechanism 36. A wide variety of flexible materials may be used for the attaching member 34, such as plastics, fiberglass, or vulcanized fiber. The attaching member 34 also defines a plurality of finger portions 38 that extend generally radially inwardly toward a central axis. The finger portions 38 are bendable and cooperate with a threaded fastening element 40 in a known fashion. By being bendable they may conform to a dished center of the back-up pad. The threaded fastening element 40 cooperates with a threaded opening 42 in the driving assembly 21. The finger portions 38 tend to bend inwardly in a central recess in the surface of the driving assembly when the adapter assembly 30 is secured to the driving assembly. Other kinds of attaching systems are contemplated.

Reference is now made to the attachment mechanism 36. The attachment mechanism 36 may include a wide variety of suitable releasable attaching devices, such as an appropriate hook or loop fastening element, a pressure sensitive adhesive, or any other known releasable attachment mechanism. In the exemplary embodiment, the attachment mechanism 36 may include a plurality of hook elements 50. It will be appreciated that the hook elements 50 would cooperate with appropriate loop elements (not shown) on the abrasive article. It will be understood that the attachment mechanism 36 may be selected so as to be compatible to the attachment mechanism 18 located on the flexible abrading article 12. In one exemplary embodiment, the releasable attaching mechanism may be a disk that can be of a relatively stiff backing material having limited flexibility and low affinity to hooks. An example of this kind of material would be a woven cloth scrim having non-woven synthetic fibers made with an adhesive resin to secure the fibers to the scrim and create a loop surface. For example, the present disclosure contemplates use of a belt material that is made of non-woven polyester fiber that is secured to a polyester scrim and a urethane adhesive that is commercially available from 3M Company as a Type T-LS belt. This material is highly effective using the 3M HOOKIT II™ abrasive system. Of course, other similar materials may be acceptable. The present invention contemplates a wide range of materials that provide for the stiffness, as noted above, for use with compatible releasable engagement mechanisms.

FIG. 3B illustrates another exemplary embodiment wherein the attachment mechanism may comprise a plurality of separate attachment elements 36a that are relatively circumferentially spaced apart as illustrated. Clearly, other sized, shaped, and spaced attachment elements are within the scope of the present description.

While the previous descriptions have referred to active engagement surfaces, there are contemplated surfaces that do not have any attachment mechanisms added thereto, but merely provide surfaces for attachment. In such an alternative exemplary embodiment, the present description envisions just a stiffening assembly that may have a surface that may be attachable to at least one pressure adhesive member on the abrasive article, and the opposing major surface thereof has a surface that may engage with a pressure sensitive adhesive of the abrading article. The stiffening assembly would be constructed to resist deformation while carrying an abrasive article during abrading such that the latter remains in an abrading plane. The present disclosure may take on various modifications and alterations without departing from the spirit and scope. Accordingly, this disclosure is not limited to the above described embodiments, but is to be controlled by limitations set forth in the following claims.

What is claimed is:

1. An apparatus comprising: an adapter body having at least a first major surface; and a releasable attachment mechanism on the first major surface for releasable meshing engagement to a matable attaching mechanism of a flexible surface modifying article; the adapter body has a construction such that when the mating attaching mechanism of the flexible surface modifying article is peeled from meshing engagement from the mating attachment mechanism, tighter meshing engagement therebetween is inhibited because the adapter body resists bending.

2. The apparatus of claim 1, wherein the adapter body includes at least one stiffening portion that resists deformation of the flexible surface modifying article when the stiffening portion directly supports the flexible surface modifying article on the first major surface for modifying a working surface so that the flexible surface modifying article substantially remains in a surface modifying plane while modifying the working surface

3. The apparatus of claim 1, wherein the adapter body includes a second major surface opposing the first major surface and is adapted engage a surface of a driving assembly.

4. The apparatus of claim 3, wherein the stiffening portion has a generally annular configuration and defines the second major surface for direct mounting on the driving element.

5. The apparatus of claim 1, wherein the releasable attachment mechanism includes one of hook and loop attachment elements.

6. The apparatus of claim 1, wherein the attachment mechanism on the first major surface is provided with a plurality of releasable attachment elements coupled in spaced apart relationship to each other and positioned adjacent a peripheral edge of the adapter body.

7. The apparatus of claim 1, wherein the stiffening portion includes a stiffening element that is sized and shaped to generally conform to at least a periphery of the driving element.

8. The apparatus of claim 3, wherein the adapter body includes an attaching member located intermediate the first and second surfaces and has portions thereof that cooperate with a fastening element that attaches the adapter body to the driving element.

9. The apparatus of claim 8, wherein the attaching member includes a generally planar body for supporting the stiffening portion on one major surface thereof, and for supporting the releasable attachment mechanisms on an opposing major surface thereof.

10. The apparatus of claim 8, wherein the attaching member includes radially inwardly directed finger portions that cooperate with a threaded fastener element so that the attaching member tightly engages the driving element.

11. A method of enabling at least one flexible surface modifying article having a releasable attaching mechanism on one major surface thereof to be attached to and detached from an abrading tool having a driving member, the method comprises: providing an adapter body joinable to the driving member and having at least a first major surface with a releasable attaching mechanism, and a construction such that when the mating attaching mechanism of the flexible surface modifying article is peeled from meshing engagement from the mating releasable attachment mechanism, tighter meshing engagement therebetween is inhibited because the adapter body resists bending.

12. The method of claim 11, further comprising: at least one stiffening portion that resists deformation of a surface modifying article when the stiffening portion directly supports a flexible surface modifying article for modifying a working surface so that the flexible surface modifying article substantially remains in a plane.

13. An apparatus adapted to carry a flexible surface modifying article, the apparatus comprises: an adapter body including first and second opposing major surfaces, wherein the first major surface is adapted to be releaseably attached to a surface of a flexible surface modifying article, and the second major surface is adapted to be coupled to a driving element of a power driven assembly; the adapter body includes at least one stiffening portion that resists deformation of the flexible surface modifying article when the stiffening portion directly supports the flexible surface modifying article on the first major surface for modifying a working surface so that the flexible surface modifying article substantially remains in a surface modifying plane while modifying the working surface, the adapter body includes an attaching member located intermediate the first and second surfaces and has portions thereof that cooperate with a fastening element that attaches the adapter body to the driving element.

14. The apparatus of claim 13, wherein the stiffening portion includes a stiffening element that is sized and shaped to generally conform to at least a periphery of the driving element.

15. The apparatus of claim 14, further including more than one releasable attachment mechanism that are supported by the stiffening element.

16. The apparatus of claim 14, wherein the stiffening element has a generally annular configuration and defines the second major surface for direct mounting on the driving element.

17. The apparatus of claim 14, wherein the adapter body includes an attaching member and has portions thereof that cooperate with a fastening element that attaches the adapter body to the driving element.

18. The apparatus of claim 17, wherein the attaching member includes a generally planar body for supporting the stiffening element on one major surface thereof, and for supporting the releasable attachment mechanisms on an opposing major surface thereof.

19. The apparatus of claim 17, wherein the attaching member includes radially inwardly directed finger portions that cooperate with a threaded fastener element so that the attaching member tightly engages the driving element.
